(19) United States
(12) Patent Application Publication
(10) Pub. No.: US 2014/0007447 A1
(43) Pub. Date: Jan. 9, 2014

(54) SLUDGE DRYING SYSTEM

(71) Applicant: SHANGHAI FUBO ENVIRONMENTAL EQUIPMENT CO., LTD., Shanghai (CN)

(72) Inventor: Xuelue QIAN, Shanghai (CN)

(73) Assignee: SHANGHAI FUBO ENVIRONMENTAL EQUIPMENT CO., LTD., Shanghai (CN)

(21) Appl. No.: 14/027,259

(22) Filed: Sep. 16, 2013

Related U.S. Application Data
(63) Continuation-in-part of application No. PCT/CN2011/084201, filed on Dec. 19, 2011.

(30) Foreign Application Priority Data
Mar. 16, 2011 (CN) 201110063174.9

(51) Int. Cl. F26B 23/00

(52) U.S. Cl. CPC F26B 23/001
USPC 34/86

(57) ABSTRACT

A sludge drying system using steam extracted from a boiler unit. The sludge drying system includes a boiler flue, boiler feedwater pipes, an extraction system, a sludge drier, and a waste heat utilization device. A deaerator and an economizer are disposed on the boiler feedwater pipes. The economizer functions as a heating surface and is arranged in the boiler flue. A water outlet pipe of the deaerator is connected to a water inlet pipe of the economizer. The sludge drier is connected to the extraction system. The waste heat utilization device includes a heat absorption member and a heat release member which communicate with one another through circulating pipes. The heat absorption member functions as a final heat surface and is disposed in the boiler flue. The heat release member is disposed on a water inlet pipe of the deaerator.

### CROSS-REFERENCE TO RELATED APPLICATIONS

This application is a continuation-in-part of International Patent Application No. PCT/CN2011/084201 with an international filing date of Dec. 19, 2011, designating the United States, now pending, and further claims priority benefits to Chinese Patent Application No. 201110063174.9 filed Mar. 16, 2011. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 14781 Memorial Drive, Suite 1319, Houston, Tex. 77079.

### BACKGROUND OF THE INVENTION

1. Field of the Invention

The invention relates to a sludge drying system, and more particularly to a sludge drying system using steam extracted from a boiler unit having thermal compensation.

2. Description of the Related Art

Conventional sludge treating methods have a strict requirement on the water content of the sludge. Generally, wet sludge after preliminary treatment of a sewage treatment plant contains 80% of water, which cannot achieve the requirement of water reduction and resource saving. Thus, the drying of the wet sludge is a must in the sewage treatment.

The drying of the wet sludge is achieved by heat. The utilization of the heat is in two forms: direct utilization and indirect utilization.

Direct utilization: the fume at a high temperature is directly introduced to a dryer to allow heat transfer between the fume and the wet material by contact and convection. This means is characteristic in a high efficiency of the heat utilization. But if the dried material has properties of pollutants, the discharge of the dried material still remains a problem. As the high temperature fume continuously enters the flue, the waste gas that has the same flow quantity and directly contact with the wet material is required to be specially treated before the discharge. Besides, acid gas in the fume has a certain degree of corrosive effect on the drying device, thereby affecting the service life of the drying device. Furthermore, the energy degree of the fume at the temperature of 140° C. is low, thereby resulting in a low drying efficiency.

Indirect utilization: heat energy of the high temperature fume is transferred to a certain medium, which may be conduction oil, water vapor, or the air, by using a heat exchanger. The medium is circulated in a closed loop, and has no contact with the material to be dried. The fume is normally discharged after part of the heat energy is utilized. The indirect utilization has a certain heat loss, and faces the following two problems:

First, the low temperature fume is corrosive to the device that has a contact surface with the fume, and how to recover the waste heat of this part of the fume?

Second, compared with the method which directly uses this part of the fume to dry the wet sludge, the indirect utilization has a much lower degree of heat energy, so that it is more difficult to dry the wet sludge.

### SUMMARY OF THE INVENTION

In view of the above-described problems, it is one objective of the invention to provide a sludge drying system using steam extracted from a boiler unit having thermal compensation.

To achieve the above objective, in accordance with one embodiment of the invention, there is provided a sludge drying system using steam extracted from a boiler unit, the sludge drying system comprises: a boiler flue, boiler feedwater pipes, and an extraction system, a deaerator and an economizer being disposed on the boiler feedwater pipes. The economizer functions as a heating surface and being arranged in the boiler flue. A steam inlet pipe of the deaerator is connected to the extraction system. A water outlet pipe of the deaerator being connected to a water inlet pipe of the economizer. The sludge drying system further comprises a sludge drier and a waste heat utilization device. The sludge drier is connected to the extraction system. The waste heat utilization device comprises a heat absorption member and a heat release member which communicate with one another through circulating pipes. The heat absorption member functions as a final heat surface and is disposed in the boiler flue. The heat release member is disposed on a water inlet pipe of the deaerator.

In a class of this embodiment, the sludge drier comprises a steam heater comprising a steam inlet pipe and a steam outlet pipe, the steam inlet pipe is connected to the extraction system, and the steam outlet pipe is connected to a condensate tank.

In a class of this embodiment, the sludge drying system further comprises a sludge tank and a steam recovery system, the sludge tank is connected to the sludge drier, and the sludge drier is connected to the steam recovery system via an air circulating pipe.

In a class of this embodiment, the steam recovery system comprises a condenser, a blower, and a sewage treatment system, the condenser is connected to the sludge drier via the air circulating pipe, the blower is disposed on the air circulating pipe, and a water outlet of the condenser is connected to the sewage treatment system.

In a class of this embodiment, the condenser is equipped with a sprinkler, and the sprinkler is connected to a water supply pump.

In a class of this embodiment, the water inlet pipe of the deaerator comprises two branches, both branches comprising a flow control valve, and the heat release member is disposed on one of the branches.

In a class of this embodiment, the sludge drying system further comprises a control system and a temperature sensor. The temperature sensor is disposed on the heat absorption member, the steam inlet pipe of the steam heater is equipped with a flow control valve, and the temperature sensor and the flow control valves all are connected to the control system.

In a class of this embodiment, the sludge drying system further comprises a low pressure heater, the low pressure heater and the heat release member are disposed on two water inlet branches of the deaerator, respectively, and a steam inlet pipe of the low pressure heater is connected to the extraction system.

In a class of this embodiment, the steam inlet pipe of the steam heater is connected to the steam inlet pipe of the low pressure heater.

In a class of this embodiment, the steam inlet pipe of the steam heater is connected to the steam inlet pipe of the deaerator.

In the above technical scheme, the sludge drying system of the invention employs part of the extracted steam of the boiler unit to heat and dry the sludge. Based on the prevention of acid dew corrosion, the waste heat of the discharged fume from the boiler is recovered at an utmost degree; the fume is prevented from contact with the sludge. Thus, the production of the harmful waste gas is prevented, the energy consumption and the cost for drying the wet sludge and are lowered.

### BRIEF DESCRIPTION OF THE DRAWINGS

FIG. 1 is a schematic diagram of a sludge drying system using steam extracted from a boiler unit in accordance with one embodiment of the invention; and

FIG. 2 is a schematic diagram of a sludge drying system using steam extracted from a boiler unit in accordance with another embodiment of the invention.

In the drawings, the following reference numbers are used: 1. Boiler flue; 2. Economizer; 3. Sludge drier; 4. Heat absorption member; 5. Heat release member; 6. Deaerator; 7. Heater; 8, 16, and 17. Flow control valve; 9. Sludge tank; 10. Condensate tank; 11. Condenser; 12. Blower; 13. Feedwater pump; 14. Control system; and 15. Temperature sensor.

### DETAILED DESCRIPTION OF THE EMBODIMENTS

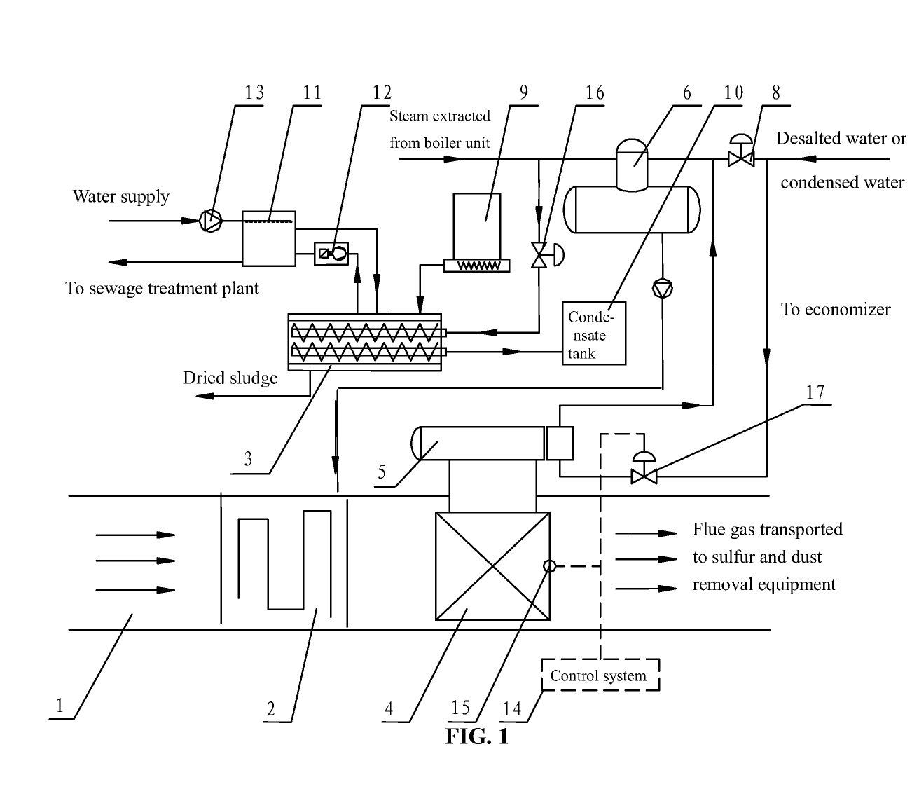

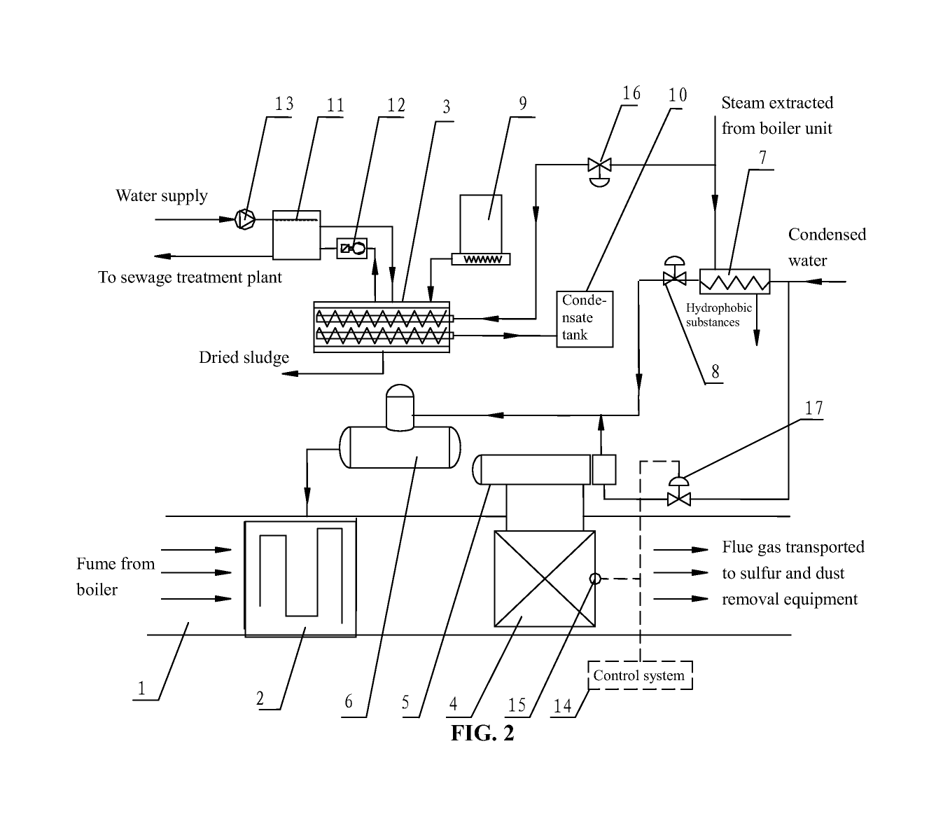

As shown in FIGS. 1 and 2, a sludge drying system using steam extracted from a boiler unit having thermal compensation, the sludge drying system comprises a boiler flue 1, boiler feedwater pipes, and an extraction system, a deaerator 6 and an economizer 2 being disposed on the boiler feedwater pipes. The economizer functions as a heating surface and is arranged in the boiler flue. A steam inlet pipe of the deaerator 6 is connected to the extraction system. A water outlet pipe of the deaerator 6 is connected to a water inlet pipe of the economizer. The sludge drying system further comprises a sludge drier 3 and a waste heat utilization device. The sludge drier is connected to the extraction system. The waste heat utilization device comprises a heat absorption member 4 and a heat release member 5 which communicate with one another through circulating pipes, the heat absorption member 4 functions as a final heat surface and is disposed in the boiler flue. The water inlet pipe of the deaerator comprises two branches, and the heat release member 5 is disposed on one of the branches. The sludge drying system of the invention employs the extracted steam of the extraction system of the boiler unit to dry the sludge and allow the fume to not contact with the sludge and the waste heat of the fume to be fully utilized. In a constant steam quantity extracted by the extraction system, as one part of the extracted steam is used to dry the sludge, the volume of extracted steam for heating the boiler correspondingly decreases. Thus, the heat quantity of the water entering the economizer decreases. In order to compensate this part of heat loss, thermal compensation was employed to ensure the thermodynamic equilibrium of the boiler unit.

Thermal compensation is achieved by using a waste heat utilization device to absorb the waste heat of part of the fume and allow the heat to return to the thermal system of the boiler unit by means of heating the make-up water of the boiler or the condensed water. An exhaust temperature of the boiler is between 140 and 160° C., whereas a temperature of the heated make-up water of the boiler or the condensed water is between 20 and 60° C. If the fume directly transfers heat to the make-up water of the boiler or the condensed water, a temperature of the wall surface of the heat exchanger is close to an acid dew point of the fume, thereby resulting in acid dew corrosion on the heat exchanger. In order to prevent the problem, the waste heat utilization device is composed of a heat absorption member 4 and a heat release member 5. The heat absorption member 4 is disposed inside the boiler flue for absorbing heat and transferring the heat to a working medium; and in the heat release member 5, the working medium transfers the heat to the make-up water or the condensed water. Working principle of the working medium is that the working medium is generally high temperature forced circulating water or naturally circulating steam having a heat transfer coefficient far higher than the side close the fume, so that the temperature of the wall surface is determined by the side close the working medium.

The sludge drying system further comprises: a sludge tank 9, a condensate tank 10, and a steam recovery system. The sludge tank 9 is connected to the sludge drier 3. A steam heater inside the sludge drier 3 comprises a steam outlet pipe being connected to the condensate tank 10. The steam is condensed and transformed into condensed water after drying the sludge. The condensed water is stored inside the condensate tank 10 and can be added to the deaerator or for other use. The sludge drier 3 is connected to the steam recovery system via the circulating pipe. The steam recovery system comprises a condenser 11, a blower 12, and a sewage treatment system. The condenser 11 is connected to the sludge drier 3 via the air circulating pipe. The blower is disposed on the air circulating pipe, and a water outlet of the condenser is connected to the sewage treatment system. The condenser 11 is equipped with a sprinkler, and the sprinkler is connected to a water supply pump 13.

The wet sludge from the water treatment plant often contains 80% of water. The sludge was stored in the sludge tank 9 that is provided with a push plate. The push plate is driven by a hydraulic or electric device to prevent the sludge from being agglomerated on the push plate and from affecting the discharge of the dried sludge. The sludge drier 3 transfers the heat of the steam to the sludge so that water in the sludge is evaporated into steam and discharged out by the circulating air. The blower 12 in the steam recovery system extracts the steam produced in the sludge drier 3 and part of evaporated gas to the condenser 11 by the circulating pipe, and to the sludge drier 3 again after being condensed. The condenser 11 works by spraying water to achieve condensation. The condensed water is pumped by the water supply pump 13 from a water tank into the spraying condenser. The water is atomized by the sprinkler and then fully contact with the circulating air for cooling the air. The cooled air is discharged from an upper part of the condenser 11. Part of water vapor in the circulating air after being cooled is condensed into liquid water, discharged from the water outlet at a bottom of the condenser, and enters the sewage treatment system. One or more sludge driers are provided according to the water treatment capacity, the drying degree of the sludge, the temperature and the flow rate of the fume.

As part of the evaporated gas in the sludge continuously enters the circulating air, the volume of the circulating air increases. Exhaust pipes are arranged on the circulating pipe to introduce the gas to an adjacent incinerator. The energy of the evaporated gas is recovered by combustion, and the odor is removed. Or other methods are employed to reduce the environment pollution.

As an embodiment of the invention, as shown in FIG. 1, the deaerator 6 and the economizer 2 are disposed on the boiler feedwater pipes. The water outlet pipes of the deaerator 6 are connected to the water inlet pipe of the economizer 2 via the water pump. The steam heater is arranged inside the sludge drier 3, the steam inlet pipe of the steam heater communicates with a steam inlet pip of the deaerator 6, and a steam outlet pipe of the steam heater communicates with the condensate tank. The water inlet pipe of the deaerator 6 comprises two branches and the heat release member 5 is disposed on one of the branches. The feedwater of the boiler enters the deaerator 6 from two branches. One branch of feedwater passes through the heat release member 5 for absorbing heat and enters the deaerator 6; and the other branch of feedwater directly enters the deaerator 6. The feedwater from the deaerator 6 passes through the water pump and enters the economizer 2. A first flow control valve 17 is arranged on the water inlet pipe of the heat release member 5. A second flow control valve 8 is arranged on the other branch of the water inlet pipe of the deaerator 6. A constant water quantity entering the deaerator 6 is ensured by controlling the first and the second flow control valves 17, 8.

The sludge drying system of the invention further comprises: a control system 14, a temperature sensor 15, and the first and the second flow control valves 17, 8. The temperature sensor 15 and the flow control valves are connected to the control system. The temperature sensor 15 is disposed on the heat absorption member 4. The water inlet pipe of the heat release member 5 is provided with the first flow control valve 17. The other branch of the water inlet pipe of the deaerator 6 is provided with the second flow control valve 8. The steam inlet pipe of the steam heater is equipped with a third flow control valve 16 for controlling the steam quantity entering the sludge drier. By controlling the temperature sensor 15 arranged on the heat absorption member 4 of the waste heat utilization device and the first flow control valve 7 arranged on the water inlet pipe of the heat release member 5 by the control system, the control system is capable of adjusting the wall temperature of the heat absorption member to allow the wall temperature of the heat absorption member be always higher than the acid dew point of the fume in accordance with the load of the boiler, so that the waste heat of the fume can be recovered to the utmost.

As another embodiment of the invention, as shown in FIG. 2, the boiler feedwater pipes are also provided with the low pressure heater 7 besides the economizer and the deaerator. The deaerator and the low pressure heater are respectively connected to the extraction system. The low pressure heater 7 and the heat release member 5 are disposed on two branches of the water inlet pipes of the deaerator 6, respectively. One branch of feedwater passes through the low pressure heater 7 and enters the deaerator, and the other branch of the feedwater passes through the heat release member to enter the deaerator. The steam inlet pipe of the steam heater is connected to the steam inlet pipe of the deaerator 6, or connected to the steam inlet pipe of the low pressure heater 7. The third flow control valve 16 is disposed on the steam inlet pipe of the steam heater. Whenever the sludge drier is connected to the deaerator or connected to the low pressure heater, the sludge drier employs the extracted steam to dry the sludge.

The sludge drying system of the invention further comprises: the control system 14, the temperature sensor 15, and the first and the second flow control valves 17, 8. The temperature sensor 15 and the flow control valves are connected to the control system. The temperature sensor 15 is disposed on the heat absorption member 4. The water inlet pipe of the heat absorption member 4 is provided with the first flow control valve 17. The other branch of the water inlet pipe of the deaerator 6 is provided with the second flow control valve 8. The steam inlet pipe of the steam heater of the sludge drier is equipped with a third flow control valve 16 for controlling the steam quantity entering the sludge drier. The invention employs the recovered waste heat of the fume to heat the feedwater of the boiler, and further employs the steam of the feedwater to dry the sludge. Thus, the equilibrium of the original thermodynamic system is ensured, and the waste heat of the fume discharged from the boiler is utilized to dry the sludge.

The invention claimed is:

1. A sludge drying system using steam extracted from a boiler unit, the sludge drying system comprising:
a) a boiler flue (1);
b) boiler feedwater pipes, the boiler feedwater pipes being equipped with a deaerator (6) and an economizer (2), the deaerator (6) comprising a steam inlet pipe, a water outlet pipe, and a water inlet pipe;
c) an extraction system;
d) a sludge drier (3); and
e) a waste heat utilization device, the waste heat utilization device comprising a heat absorption member (4) and a heat release member (5);
wherein
the economizer functions as a heating surface and is arranged in the boiler flue;
the steam inlet pipe of the deaerator (6) is connected to the extraction system, and the water outlet pipe of the deaerator (6) is connected to a water inlet pipe of the economizer;
the sludge drier is connected to the extraction system; and
the heat absorption member (4) and the heat release member (5) communicate with one another through circulating pipes, the heat absorption member (4) functions as a final heat surface and is disposed in the boiler flue, and the heat release member (5) is disposed on the water inlet pipe of the deaerator (6).

2. The sludge drying system of claim 1, wherein the sludge drier comprises a steam heater comprising a steam inlet pipe and a steam outlet pipe, the steam inlet pipe is connected to the extraction system, and the steam outlet pipe is connected to a condensate tank (10).

3. The sludge drying system of claim 2, wherein the sludge drying system further comprises a sludge tank (9) and a steam recovery system, the sludge tank (9) is connected to the sludge drier (3), and the sludge drier (3) is connected to the steam recovery system via an air circulating pipe.

4. The sludge drying system of claim 3, wherein the steam recovery system comprises a condenser (11), a blower (12), and a sewage treatment system, the condenser (11) is connected to the sludge drier (3) via the air circulating pipe, the blower is disposed on the air circulating pipe, and a water outlet of the condenser is connected to the sewage treatment system.

5. The sludge drying system of claim 4, wherein the condenser (11) is equipped with a sprinkler, and the sprinkler is connected to a water supply pump (13).

6. The sludge drying system of claim 2, wherein the water inlet pipe of the deaerator comprises two branches, both branches comprising a flow control valve (8, 17), and the heat release member (5) is disposed on one of the branches.

7. The sludge drying system of claim 6, wherein the sludge drying system further comprises a control system (14) and a temperature sensor (15), the temperature sensor is disposed on the heat absorption member (4), the steam inlet pipe of the steam heater is equipped with a flow control valve (16), and the temperature sensor (15) and the flow control valves (8, 16, 17) all are connected to the control system.

8. The sludge drying system of claim 6, wherein the sludge drying system further comprises a heater (7), the heater (7) and the heat release member (5) are disposed on two water inlet branches of the deaerator (6), respectively, and a steam inlet pipe of the heater (7) is connected to the extraction system.

9. The sludge drying system of claim 8, wherein the steam inlet pipe of the steam heater is connected to the steam inlet pipe of the heater (7).

10. The sludge drying system of claim 2, wherein the steam inlet pipe of the steam heater is connected to the steam inlet pipe of the deaerator (6).
